(19) United States
(12) Patent Application Publication
(10) Pub. No.: US 2025/0297897 A1
(43) Pub. Date: Sep. 25, 2025

(54) SLOT DEVICE

(71) Applicant: Fulian Precision Electronics (Tianjin) Co., LTD., Tianjin (CN)

(72) Inventors: CHIA-YI WU, New Taipei (TW); YUN-CHENG HSIEH, New Taipei (TW)

(21) Appl. No.: 18/963,910

(22) Filed: Nov. 29, 2024

Related U.S. Application Data
(60) Provisional application No. 63/568,517, filed on Mar. 22, 2024.

(51) Int. Cl. G01K 1/143; G01K 1/16; G01K 13/00; G06F 1/18

(52) U.S. Cl. CPC G01K 1/143; G01K 1/16; G01K 13/00; G06F 1/185

(57) ABSTRACT

A slot device is disclosed in the present application. The slot device includes a slot body a flexible circuit board, and a sensor assembly, the slot body defines a slot for inserting an object, the flexible circuit board is disposed on the slot body, the sensor assembly is configured to obtain sensing data of the object inserted into the slot body, when the object is inserted into the slot, the object contacts the flexible circuit board and deforms the flexible circuit board to move the sensor assembly from a first position to a second position. The slot device can protect the sensor assembly and has low cost. This application can reduce the problem of friction and collision between the object and the sensor assembly, provide protection for the sensor assembly, and improve the accuracy of the sensing data obtained by the sensor assembly.

### FIELD

The present application relates to the field of electronic devices, and particularly to a slot device.

### BACKGROUND

Usually, after inserting a memory card into a motherboard slot, a temperature sensor is needed to monitor its temperature, and the closer the temperature sensor is to the memory, the more accurate the monitoring data will be. The memory card is frequently plugged and unplugged and can easily cause friction or collision with the temperature sensor, causing the temperature sensor to be damaged or malfunction. Related art can use a very precise and appropriately sized motherboard slot to install the temperature sensor, to reduce the friction and collision of the temperature sensor when the memory is plugged and unplugged. However, this method is not guaranteed to reduce the friction and collision, the process requirements are high, and the cost is high. In addition, due to the relative position of the temperature sensor and the memory card is fixed, if the distance between the temperature sensor and the memory card is too large, it is difficult for the temperature sensor to be close to the memory card to obtain accurate sensing data.

Therefore, improvement is desired.

### BRIEF DESCRIPTION OF THE DRAWINGS

Implementations of the present application will now be described, by way of embodiments, with reference to the attached figures.

FIG. 1 is a schematic diagram of inserting a memory card into a motherboard slot.

FIG. 2 is a schematic diagram of an embodiment of a slot device of the present application.

FIG. 3 is a schematic diagram of an application scenario for the slot device of the present application.

FIG. 4 is an exploded view of the slot device of the present application.

FIG. 5 is a schematic diagram of an embodiment of a slot body of the present application.

FIG. 6 is a schematic diagram of an embodiment of a flexible circuit board of the present application.

FIG. 7 is a cross-sectional view of the slot device of FIG. 2.

FIG. 8 is another cross-sectional view of the slot device of FIG. 2.

### DETAILED DESCRIPTION

The technical solutions in the embodiments of the present application will be described below in conjunction with the accompanying drawings in the embodiments of the present application, and the described embodiments are only a portion of the embodiments of the present application and not all of the embodiments.

In the description of the embodiments of the present application, the terms “exemplary”, “or”, and “for example” are used to indicate examples, illustrations, or descriptions.

In the embodiment of the present application, the words “first” and “second” are only used to distinguish different objects and cannot be understood as indicating or implying relative importance, or as indicating or implying order.

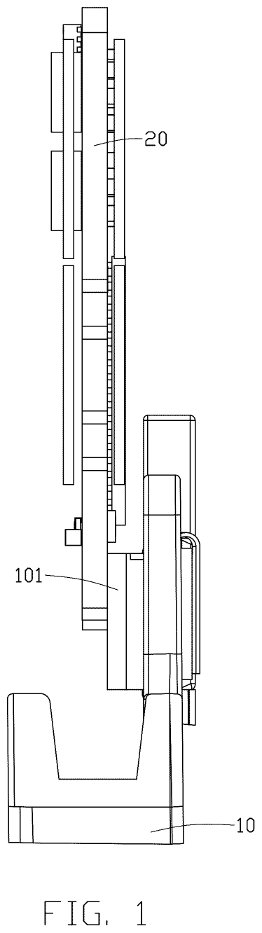

FIG. 1 illustrates a scenario where a memory card 20 is inserted into a motherboard slot 10.

When the integrated circuit (IC) of the memory card 20 is at non-operating temperature, there may be a risk of operating errors. Therefore, the memory card 20 needs to be temperature monitored using a temperature sensor 101 after it is inserted into the motherboard slot 10 (i.e., the slot device of the motherboard), and the motherboard or the entire system will allow the memory card 20 to operate only when the temperature of the memory card 20 is in the range of the operating temperature. The closer the temperature sensor 101 is to the memory stick 20 to monitor the data, the more accurate it is, preferably with a tight contact. Referring to FIG. 1, the surface of the memory card 20 is not a flat surface, and the memory card 20 needs to be frequently plugged and unplugged during use, and the relative position of the temperature sensor 101 and the memory card 20 is fixed, which can easily cause friction or collision between the memory card 20 and the temperature sensor 101, and may result in damage to the temperature sensor 101 or the memory card 20.

Related art can use a very precise and appropriately sized motherboard slot to install the temperature sensor, to reduce the friction and collision of the temperature sensor when the memory is plugged and unplugged. However, this method is to insert the memory card 20 in such a way that it maintains a very small gap with the temperature sensor 101, and therefore does not ensure that the friction collision problem is reduced, and at the same time the existence of this gap may lead to the diffusion of the heat flow making the monitoring of the temperature sensor 101 inaccurate, it is very difficult for this method to allow the temperature sensor 101 to obtain accurate monitoring data.

The present application provides a slot device that can reduce the problem of friction and collision between the object and the sensor assembly, provide effective protection for the sensor assembly, and improve the accuracy of the sensing data obtained by the sensor assembly.

Embodiments of the present application will be described below in connection with the accompanying drawings.

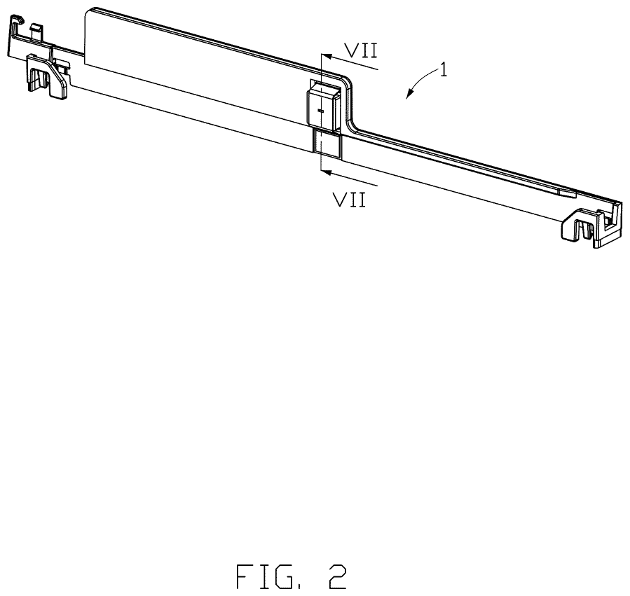

FIG. 2 illustrates a slot device 1 in accordance with an embodiment of the present application.

The slot device 1 can be installed on a computer motherboard or on a test device 3, and the slot device 1 can be used for insertion of the memory card 20 or other objects that need to be used for use in the computer motherboard or the test set 3. The slot device 1 may have slots that match dual inline memory module (DIMM) memory cards or single inline memory module (SIMM) memory cards. The memory cards or other objects that need to be used for use in the computer motherboard or the test device 3 are collectively referred to the object 2.

In some embodiments, the object 2 may include a DIMM memory card or a SIMM memory card. The object 2 may also include other types of memory cards.

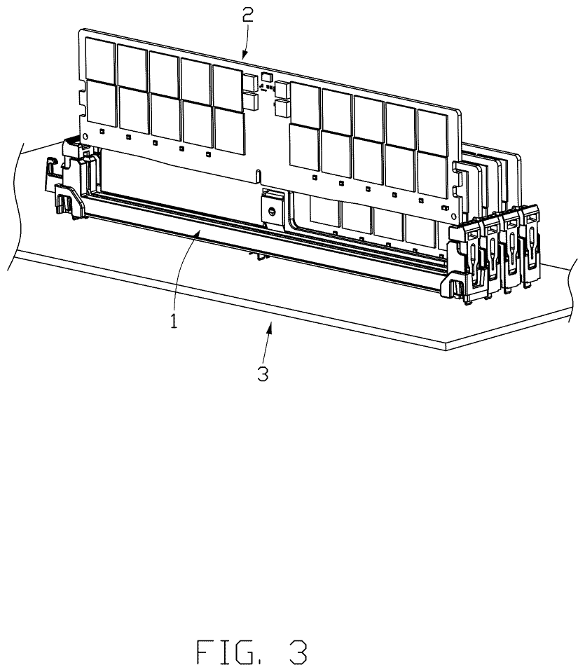

In some embodiments, referring to FIG. 3, corresponding to the number of the objects 2, the slot device 1 may be a plurality. For example, when 1, 2, 3 . . . n objects need to be plugged in on the computer motherboard or in the test device 3, they can correspond to 1, 2, 3 . . . n slot devices, and n is a positive integer.

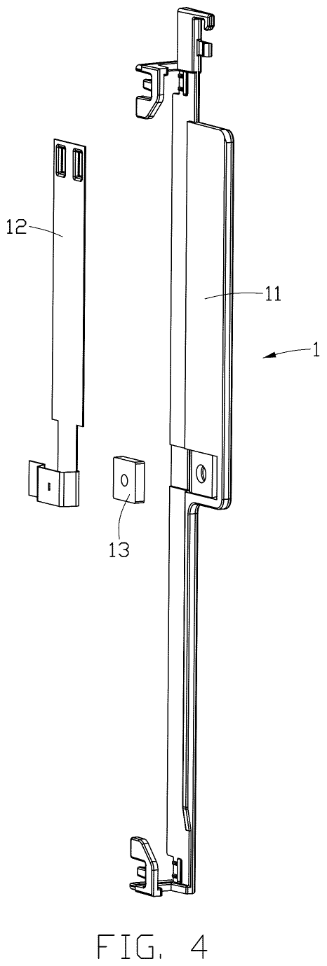

Referring to FIG. 4, the slot device 1 includes a slot body 11, a flexible circuit board 12, and a sensor assembly 13. The slot body 11 may have slots for insertion of the objects 2. The flexible circuit board 12 may be disposed on the slot body 11. The sensor assembly 13 may be disposed on the flexible circuit board 12 and located on a side of the flexible circuit board 12 close to the slot body 11, and the sensor assembly 13 may be used to obtain sensing data of the object 2 inserted in the slot body 11. The sensor assembly 13 is electrically connected to the flexible circuit board 12, and the sensor assembly 13 can transmit the sensing data through the flexible circuit board 12. In the embodiment, when the object 2 is inserted into the slot, the object 2 contacts the flexible circuit board 12 and deforms the flexible circuit board 12 to move the sensor assembly 13 from a first position to a second position.

The first position is the position of the sensor assembly 13 before the deformation of the flexible circuit board 12, and the second position is the position of the sensor assembly 13 after the deformation of the flexible circuit board 12. For example, before the deformation of the flexible circuit board 12, the sensor assembly 13 is 1 mm away from the slot body 11, and the position is the first position; after the deformation of the flexible circuit board 12, the sensor assembly 13 is 0.2 mm away from the slot body 11, and the position is the second position.

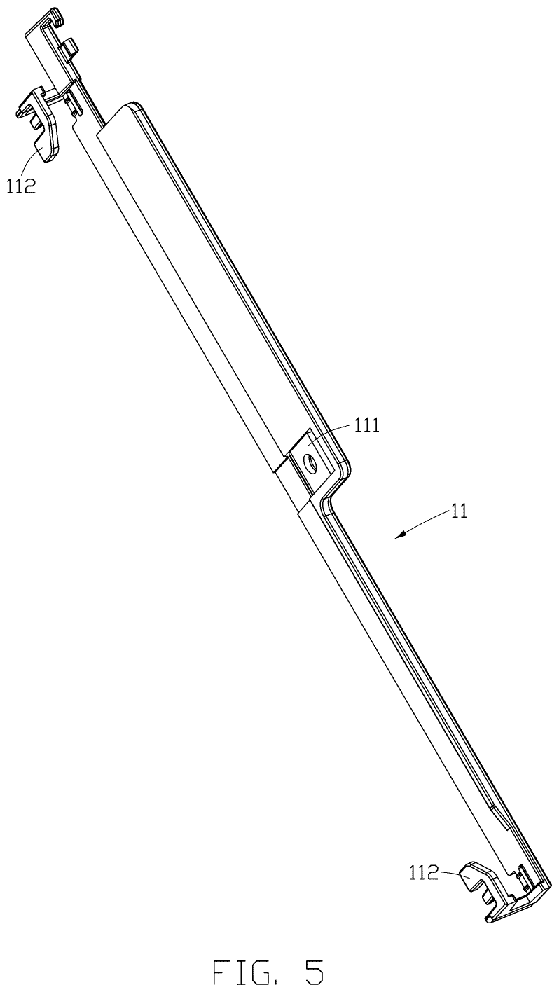

FIG. 5 is a schematic diagram of the slot body 11 of the present application.

Referring to FIG. 5, in some embodiments, the slot body 11 may have a placing portion 111 in the shape of a groove or hollow, and at least a portion of the flexible circuit board 12 may be disposed in the placing portion 111. In this case, the flexible circuit board 12 is placed in the placing portion 111, which can reduce the overall weight and space occupation of the slot device 1, thereby reducing costs and saving space for arranging more slot devices 1 on the computer motherboard or the test device 3.

The slot body 11 may be in the shape of a long plate, and a long side portion of the slot body 11 extends in the direction of a plate surface of the long plate, and then extends parallel to the plate surface of the long plate to form a hook portion 112. In the embodiment, the hook portion 112 may be used as a slot for inserting the object 2.

In some embodiments, a portion of the long plate surface of the slot body 11 has a larger area than the remaining portion. The portion with a larger area can be used to install the sensor assembly 13 and the flexible circuit board 12, while the portion with a smaller area can be used to optimize space utilization and reduce the weight of the slot body 11.

In another embodiment, the slot device 1 may also include a slot portion, a fixing portion, and a circuit connection portion. The slot portion can be used to form a slot, the slot portion is in the form of an elongated rectangular body, the rectangular body can form a groove that matches the shape of the object 2. In the embodiment, the hook portion 112 of the slot body 11 can be used to install and fix the slot portion. The hook portion 112 does not need to be used as a slot for inserting the object 2. The slot for inserting the object 2 is formed by a rectangular slot portion.

The fixing portion may be disposed in the slot portion and used to cooperate with the slot portion to fix the object 2 inserted in the slot. The fixing portion may be disposed at both ends of the slot portion. The fixing portion may be a snap mechanism disposed at both ends of the slot portion. The present application can frame the object 2 inserted into the slot and enhance the stability of the object 2 inserted into the slot device 1 through the cooperation between the slot body 11, the slot portion, and the fixing portion.

The circuit connection portion may be disposed in the slot of the slot portion, and the circuit connection portion may be used to electrically connect the motherboard and the object 2. The circuit connection portion may be disposed in the slot of the slot portion and may contact the conductive contacts (commonly known as “golden fingers”) of the object 2 when the object 2 is inserted into the slot. As a result, the motherboard is electrically connected to the object 2 through the circuit connection portion.

In some embodiments, the slot body 11, the slot portion, and the fixing portion can be made of non-metallic materials, while the circuit connection portion can be made of conductive metal materials.

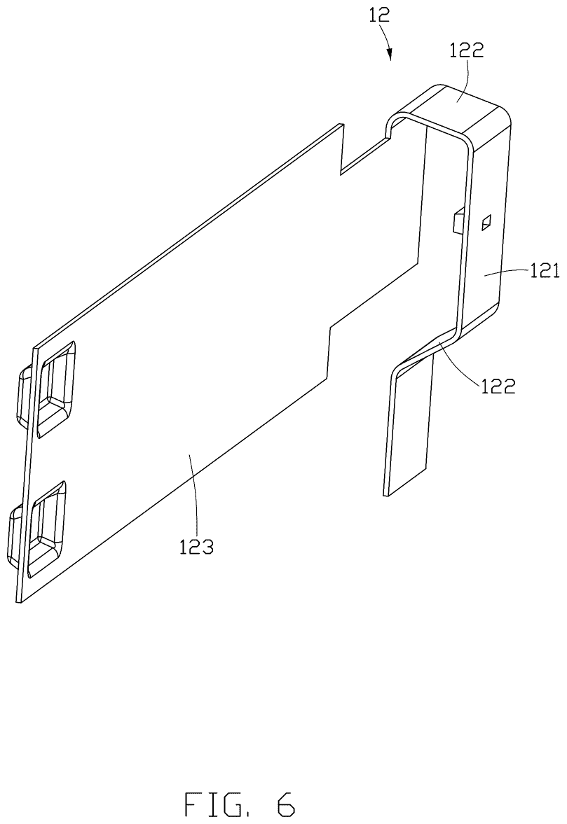

FIG. 6 is a schematic diagram of the flexible circuit board 12 of the present application.

As described above, the slot device 1 includes a flexible circuit board 12, the flexible circuit board 12 is a highly reliable and excellent flexible printed circuit board made of polyimide or polyester film as the substrate. In other words, the flexible circuit board of the present application may have a certain degree of elasticity or deformability.

In some embodiments, the flexible circuit board 12 may be constructed by embedding circuit elements in a bendable sheet of lightweight plastic. The circuit elements in the flexible circuit board 12 may enable the sensor assembly 13 to be connected to the motherboard or the test device 3, this can thereby facilitate the sensor assembly 13 to transmit the sensing data to the motherboard or the test device 3 through the flexible circuit board 12.

In some embodiments, referring to FIG. 6, the flexible circuit board 12 includes an accommodation portion 121, a partition plate 122 and a base plate 123. The accommodation portion 121 and the partition plate 122 may be portions disposed on the placing portion 111, the accommodation portion 121 and the partition plate 122 may form a containment structure, the containment structure may be used to receive the sensor assembly 13, and the sensor assembly 13 may be disposed in the accommodation portion 121 and located on a side of the accommodation portion 121 close to the slot body 11.

In some embodiments, the base plate 123 of the flexible circuit board 12 can be designed to adhere to the slot body 11. In some embodiments, the base plate 123 of the flexible circuit board 12 may define a positioning groove, and the slot body 11 may have a positioning protrusion that match the positioning groove of the base plate 123. As a result, the flexible circuit board 12 can be quickly and accurately installed on the slot body 11 by means of the positioning groove and the positioning projection, thereby enhancing the installation efficiency.

In some embodiments, the accommodation portion 121 and the partition plate 122 may be formed by extending and bending the base plate 123. More specifically, the accommodation portion 121 and the partition plate 122 may be a part of the base plate 123 that passes through a hollow area of the slot body 11 and is bent in the same direction as the insertion direction of the object 2. In the embodiment, the accommodation portion 121 is used to set the sensor assembly 13 and to be close to the object 2 after the object 2 is inserted; the partition plate 122 is used to counteract the friction and collision of the object 2 during the insertion of the object 2, and can accordingly telescope and deform to change the position of the sensor assembly 13 disposed on the accommodation portion 121, thereby further providing effective protection for the sensor assembly 13.

As mentioned above, the partition plate 122 can be formed in the same direction as the insertion direction of the object 2 in the accommodating portion 121. In some embodiments, the partition plate 122 may have a preset tilt angle, for example, the preset tilt angle may be 45°, 60°, or 75°, etc. The preset tilt angle may be an angle range of 0° to 90°.

The flexible circuit board 12 of the present application can be made of materials including insulating film, conductor, and adhesive. The insulating film may be used as a protective cover to isolate circuits from dust and moisture, and to reduce stress during bending. The conductor may be used to form conductive layers. The adhesive may be used to bond the insulating film to the conductive layer. The insulating film can be made of polyimide and polyester materials, and the conductor can include copper foil, which is formed in the insulating film by electrodeposition (ED) or plating method.

In some embodiments, the material of the flexible circuit board 12 may not include adhesive. In the flexible circuit board 12, the stacked layers without adhesive can form thinner circuits with greater flexibility. The present application has a better thermal conductivity compared to a stacked layer construction using an adhesive as a base. In this case, due to the thin structure characteristics of adhesive free flexible circuits and the elimination of the thermal resistance of adhesives, the thermal conductivity is improved, the deformation and high thermal conductivity characteristics of the flexible circuit board 12 can thus be utilized to protect the sensor assembly 13, while also enhancing the accuracy of the sensing data acquired by the sensor assembly 13.

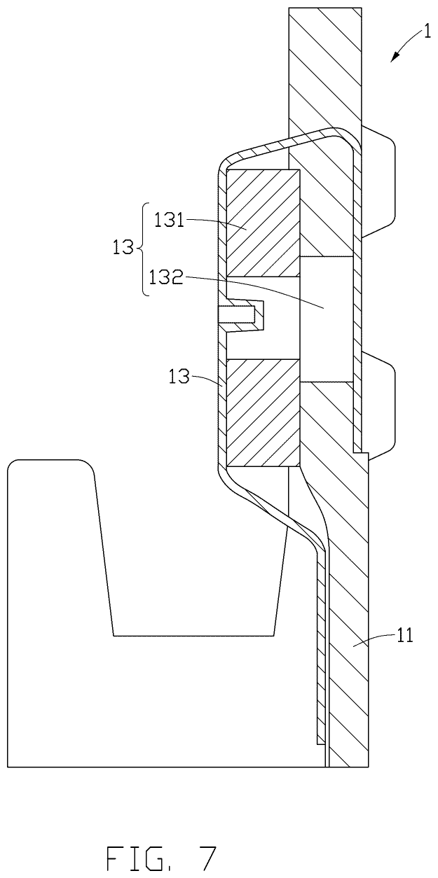

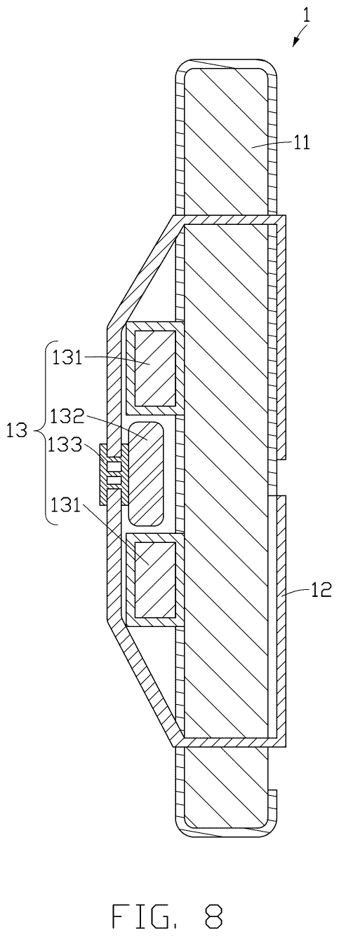

FIG. 7 is a cross-sectional view of the slot device of FIG. 2. FIG. 8 is another cross-sectional view of the slot device.

As described above, the slot device 1 of the present application may include a sensor assembly 13.

As shown in FIG. 7 or FIG. 8, in some embodiments, the sensor assembly 13 may include a sensor 132 and at least one elastic member 131 having elasticity, both the sensor 132 and the elastic member 131 are disposed in the accommodation portion 121 and located on a side of the accommodation portion 121 close to the slot body 11.

Referring to FIG. 8, in some embodiments, a first gap may be provided between the sensor 132 and the slot body 11, for example, the first gap may be 1 mm. Thus, when the flexible circuit board 12 deforms and causes the position of the sensor assembly 13 to change, the situation in which the sensor 132 touches the slot body 11 and is damaged can be reduced.

In some embodiments, a second gap may be provided between the elastic member 131 and the slot body 11, the second gap between the elastic member 131 and the slot body 11 is smaller than the first gap between the sensor 132 and the slot body 11, for example, the second gap may be 0.5 mm. Thus, when the flexible circuit board 12 deforms and causes the position of the sensor assembly 13 to change, the elastic member 131 may first touch the slot body 11, which serves as a cushion and reduces the situation in which the sensor 132 touches the slot body 11 and is damaged.

In another embodiment, the elastic member 131 can be filled between the accommodation portion 121 and the placing portion 111, in other words, the elastic member 131 is connected to the flexible circuit board 12, and the elastic member 131 is also connected to the slot body 11. If the object 2 is inserted into the slot device 1, the flexible circuit board 12 will deform, but the position of the elastic member 131 will not change. Therefore, the position change of the sensor assembly 13 can refer to the position change of the sensor 132.

In some embodiments, the number of elastic members 131 is one, the elastic member 131 is in the form of a ring, and the sensor 132 is located at the center of the ring of the elastic member 131. The resilient member 131 may be one of a square ring, a rectangular ring, or a circular ring. In this case, the ring-shaped elastic member 131 may provide all-around protection for the sensor 132.

In some embodiments, the number of elastic members 131 is a plurality, such as 2, 3 . . . n, where n is a positive integer, and the plurality of elastic members 131 are evenly distributed around the sensor 132. For example, the elastic members 131 may be two, in the same direction as the object 2 is inserted in the slot device 1, one elastic member 131 may be arranged above the sensor 132 and another elastic member 131 may be arranged below the sensor 132. Also for example, the elastic members 131 may be four, in the same direction as the object 2 is inserted in the slot device 1, two elastic members 131 may be arranged above the sensor 132 and the other two elastic members 131 may be arranged below the sensor 132. In this case, the elastic members 131 are plurality, which can protect the sensor 132 and reduce material costs.

In some embodiments, in an elastic member 131, the thickness of the elastic member 131 may be equal in the same direction as the insertion direction of the object 2. In some embodiments, the thickness of the plurality of elastic members 131 may be equal in the same direction as the insertion direction of the object 2. For example, the elastic members 131 may be two, in the same direction as the object 2 is inserted in the slot device 1, one elastic member 131 may be arranged above the sensor 132 and another one elastic members 131 may be arranged below the sensor 132, the elastic members 131 having equal thicknesses in the same direction as the insertion direction of the object 2, in other words, the height in the direction perpendicular to the insertion direction of the object 2 is the same. In this case, when the object 2 is inserted in, the flexible circuit board 12 can be evenly placed close to the object 2, and the overall friction impact force is small, which can enhance the life of the flexible circuit board 12.

In some embodiments, in an elastic member 131, the thickness of the elastic member 131 may be incremental in the same direction as the insertion direction of the object 2. In some embodiments, the thickness of the plurality of elastic members 131 may be incremental in the same direction as the insertion direction of the object 2. For example, the elastic members 131 may be two, in the same direction as the object 2 is inserted in the slot device 1, one elastic member 131 may be arranged above the sensor 132 and another one elastic members 131 may be arranged below the sensor 132, the thickness of the elastic members 131 is incremental in the same direction as the insertion direction of the object 2, in other words, the height of the elastic members 131 is incremental in the direction perpendicular to the insertion direction of the object 2. The thickness of the elastic member 131 disposed above the sensor 132 is less than the thickness of the elastic member 131 disposed below the sensor 132. In this case, the object 2 may be guided by the inclined flexible circuit board 12 when it is inserted in the slot device 1 for smooth insertion, and the impact force between the object 2 and the flexible circuit board 12 may be reduced, thereby improving the service life of the flexible circuit board 12.

The thickness of the elastic member 131 disposed above the sensor 132 or the elastic member 131 disposed below the sensor 132 may be incremental in the same direction as the insertion direction of the object 2, in other words, the surface of the elastic member 131 disposed above the sensor 132 or the elastic member 131 disposed below the sensor 132 that is in contact with the flexible circuit board 12 may be a sloped surface that is narrower at the top and wider at the bottom.

In some embodiments, in an elastic member 131, the thickness of the elastic member 131 may decrease in the same direction as the insertion direction of the object 2. In some embodiments, the thickness of the plurality of elastic members 131 may decrease in the same direction as the insertion direction of the object 2. For example, the elastic members 131 may be two, in the same direction as the object 2 is inserted in the slot device 1, one elastic member 131 may be arranged above the sensor 132 and another elastic member 131 may be arranged below the sensor 132, the thickness of the elastic members 131 is incremental in the same direction as the insertion direction of the object 2, in other words, the height of the elastic members 131 is incremental in the direction perpendicular to the insertion direction of the object 2, and the thickness of the elastic member 131 disposed above the sensor 132 is greater than the thickness of the elastic member 131 disposed below the sensor 132. In this case, when the object 2 is inserted into the slot device 1, due to the fact that the thickness of the elastic member 131 located above the sensor 132 is greater than the thickness of the elastic member 131 located below the sensor 132, the elastic member 131 located above the sensor 132 provides greater elasticity, thereby improving the proximity between the flexible circuit board 12 and the object 2, and thereby enhancing the accuracy of the sensor 132 in obtaining sensing data.

The thickness of the elastic member 131 disposed above the sensor 132 or the elastic member 131 disposed below the sensor 132 may be decreased in the same direction as the insertion direction of the object 2, in other words, the surface of the elastic member 131 disposed above the sensor 132 or the elastic member 131 disposed below the sensor 132 that is in contact with the flexible circuit board 12 may be a sloped surface that is wider at the top and narrower at the bottom.

In some embodiments, the elastic member 131 may include at least one elastic structure such as sponge, silicone, non-conductive spring, etc.

In some embodiments, the sensor 132 may be a temperature sensor, and the sensing data can be temperature sensing data. The sensor 132 can be a semiconductor temperature sensor, such as a temperature sensor based on bipolar junction transistor (BJT).

In another embodiments, the sensor 132 may also be various types of sensors other than temperature sensors, such as stroke sensors, current sensors, or position sensors. The sensing data may be data such as travel, electrical parameter or position.

Referring to FIG. 8, in some embodiments, the sensor assembly 13 may include at least one connection member 133 having thermal and electrical conductivity. The connection member 133 may be disposed in the accommodation portion 121, at least part of the connection member 133 is disposed on a side of the accommodation portion 121 away from the slot body 11, the connection member 133 is used to connect the sensor assembly 13 and the flexible circuit board 12.

In some embodiments, the connection member 133 may be copper, silver, gold, or other metals or alloys with good thermal and electrical conductivity.

In some embodiments, the connection member may be copper, silver, gold, or other metals or alloys with good thermal and electrical conductivity. The connection member may be set as a Via hole or a Pad hole to connect the sensor 132 and the flexible circuit board 12. Thus, the electrical connection between the sensor 132 and the flexible circuit board 12 can be achieved.

As shown in FIG. 8, in some embodiments, a part of the connection member 133 may be disposed on a surface of the flexible circuit board 12 and located on a side of the flexible circuit close to the object 2. In this case, the present application can utilize the thermal conductivity of the connection member 133 to transfer the temperature of the object 2 to the sensor 132, thereby enhancing the accuracy of the sensing data obtained by the sensor 132.

In the embodiment of the present application, since the flexible circuit board 12 has deformability and the sensor assembly 13 is disposed on the flexible circuit board 12 and is located on the side of the flexible circuit board 12 close to the slot body 11, when the object 2 is inserted into the slot body 11 through the slot, the object 2 first contacts the flexible circuit board 12 and deforms the flexible circuit board 12, and the position of the sensor assembly 13 changes accordingly, in other words, the deformation of the flexible circuit board 12 can move the sensor assembly 13 from the first position to the second position, thereby reducing the problem of friction and collision between the object 2 and the sensor assembly 13, and providing effective protection for the sensor assembly 13.

When the object 2 is inserted into the slot body 11 through the slot, the deformation ability of the flexible circuit board 12 can make it closely adhere to the object 2, thereby making the sensor assembly 13 disposed on the flexible circuit board 12 close to the object 2, thereby improving the accuracy of the sensor assembly 13 in obtaining sensing data.

The present application can protect the sensor assembly 12 when the object 2 is inserted in the slot device 1 and reduce the friction collision between the object 2 and the sensor assembly 12 by providing the protective portion 111 around the sensor assembly 12 on the slot body 11. Since the height of the protective portion 111 in a direction perpendicular to the first surface A is less than or equal to the height of the sensor assembly 12 in a direction perpendicular to the first surface A, the sensor assembly 12 can still be close to the object 2 after the object 2 is inserted in the slot device 1, thus the sensor assembly 12 can be protected without affecting the operation of the sensor assembly 12. The sensor assembly 12 is protected by the protective portion 111, and the structural design is simple, which can reduce the cost.

Even though numerous characteristics and advantages of the present technology have been set forth in the foregoing description, together with details of the structure and function of the present application, the application is illustrative only, and changes can be made in the detail, especially in matters of shape, size, and arrangement of the parts within the principles of the present application, up to and including the full extent established by the broad general meaning of the terms used in the claims. It will, therefore, be appreciated that the exemplary embodiments described above can be modified within the scope of the claims.

What is claimed is:

1. A slot device comprising a slot body; a flexible circuit board; and a sensor assembly, wherein:
the slot body defines a slot configured for receiving an object;
the flexible circuit board is disposed on the slot body; and
the sensor assembly is disposed on the flexible circuit board and located on a side of the flexible circuit board close to the slot body, the sensor assembly is configured to obtain sensing data of the object inserted in the slot body, and the sensor assembly is electrically connected to the flexible circuit board; and
wherein the slot body is further configured such that when the object is inserted into the slot, the flexible circuit board contacts the object and is deformed, by the object, to move the sensor assembly from a first position to a second position.

2. The slot device according to claim 1, wherein the slot body is provided with a placing portion, at least part of the flexible circuit board is disposed on the placing portion, and the placing portion has a groove or hollow shape.

3. The slot device according to claim 2, wherein an accommodation portion is formed on the part of the flexible circuit board that is disposed on the placing portion, the sensor assembly is disposed in the accommodation portion on a side of the accommodation portion close to the slot body, and a partition plate is formed in the accommodation portion, the partition plate extends in a same direction as an insertion direction of the slot body to receive the object.

4. The slot device according to claim 3, wherein the sensor assembly comprises a sensor and at least one elastic member, the sensor and the at least one elastic member are disposed in the accommodation portion and located on the side of the accommodation portion close to the slot body.

5. The slot device according to claim 4, wherein the sensor assembly comprises one elastic member, the elastic member is in the shape of a ring, and the sensor is located at a center of the ring of the elastic member.

6. The slot device according to claim 4, wherein the sensor assembly comprises a plurality of elastic members, and the plurality of elastic members are evenly distributed around the sensor.

7. The slot device according to claim 5, wherein a thickness of the elastic member is equal when viewed in the insertion direction.

8. The slot device according to claim 6, wherein a thickness of each of the plurality of elastic members is equal when viewed in the insertion direction.

9. The slot device according to claim 5, wherein a thickness of the elastic member is incremental when viewed in the insertion direction.

10. The slot device according to claim 5, wherein a thickness of each of the plurality of elastic members is incremental when viewed in the insertion direction.

11. The slot device according to claim 5, wherein a thickness of the elastic member decreases when viewed in the insertion direction.

12. The slot device according to claim 6, wherein a thickness of each of the plurality of elastic members decreases when viewed in the insertion direction.

13. The slot device according to claim 3, wherein the sensor assembly comprises at least one connection member having thermal conductivity and electrical conductivity, the connection member is disposed in the accommodation portion, and at least a part of the connection member is located on a side of the accommodation portion away from the slot body, the connection member connects the sensor assembly and the flexible circuit board.

14. A slot device comprising a slot body, a flexible circuit board, and a sensor assembly, wherein:
the slot body defines a slot configured for receiving an object;
the flexible circuit board is disposed on the slot body; and
the sensor assembly is disposed on the flexible circuit board and located on a side of the flexible circuit board close to the slot body, the sensor assembly is configured to obtain sensing data of the object inserted into the slot body, and the sensor assembly is electrically connected to the flexible circuit board; and
wherein the slot body is further configured such that when the object is inserted into the slot, the flexible circuit board contacts the object and is deformed, by the object, to move the sensor assembly from a first position to a second position;
wherein the slot body is provided with a placing portion, at least part of the flexible circuit board is disposed on the placing portion; the sensor assembly comprises at least one connection member, the connection member is used to connect the sensor assembly and the flexible circuit board; and
wherein an accommodation portion is formed on the part of the flexible circuit board that is disposed on the placing portion, the sensor assembly is disposed in the accommodation portion on a side of the accommodation portion close to the slot body, and a partition plate is formed in the accommodation portion, the partition plate extends in a same direction as an insertion direction of the slot body to receive the object.

15. The slot device according to claim 14, wherein the sensor assembly comprises a sensor and at least one elastic member, the sensor and the at least one elastic member are disposed in the accommodation portion and located on the side of the accommodation portion close to the slot body.

16. The slot device according to claim 15, wherein the sensor assembly comprises one elastic member, the elastic member is in the shape of a ring, and the sensor is located at a center of the ring of the elastic member.

17. The slot device according to claim 15, wherein the sensor assembly comprises a plurality of elastic members, and the plurality of the elastic members are evenly distributed around the sensor.

18. The slot device according to claim 16, wherein a thickness of the elastic member is equal when viewed in the insertion direction.

19. The slot device according to claim 16, wherein a thickness of each of the elastic member is incremented when viewed in the insertion direction.

20. The slot device according to claim 16, wherein a thickness of the elastic member is decreased in the same direction as the insertion direction of the object.
